(19) United States
(12) Patent Application Publication
(10) Pub. No.: US 2016/0110657 A1
(43) Pub. Date: Apr. 21, 2016

(54) Configurable Machine Learning Method Selection and Parameter Optimization System and Method

(71) Applicant: Skytree, Inc., San Jose, CA (US)

(72) Inventors: Maxsim Gibiansky, Sunnyvale, CA (US); Ryan Riegel, San Jose, CA (US); Yi Yang, Sunnyvale, CA (US); Parikshit Ram, Atlanta, GA (US); Alexander Gray, Santa Clara, CA (US)

(21) Appl. No.: 14/883,522

(22) Filed: Oct. 14, 2015

Related U.S. Application Data
(60) Provisional application No. 62/063,819, filed on Oct. 14, 2014.

(51) Int. Cl. G06N 99/00

(52) U.S. Cl. CPC G06N 99/005

(57) ABSTRACT

A system and method for selecting a machine learning method and optimizing the parameters that control its behavior including receiving data; determining, using one or more processors, a first candidate machine learning method; tuning, using one or more processors, one or more parameters of the first candidate machine learning method; determining, using one or more processors, that the first candidate machine learning method and a first parameter configuration for the first candidate machine learning method are the best based on a measure of fitness subsequent to satisfaction of a stop condition; and outputting, using one or more processors, the first candidate machine learning method and the first parameter configuration for the first candidate machine learning method.

### CROSS-REFERENCE TO RELATED APPLICATIONS

The present application claims priority, under 35 U.S.C. §119, of U.S. Provisional Patent Application No. 62/063,819, filed Oct. 14, 2014 and entitled “Configurable Machine Learning Method Selection and Parameter Optimization System and Method for Very Large Data Sets,” the entirety of which is hereby incorporated by reference.

### BACKGROUND OF THE INVENTION

1. Field of the Invention

The disclosure is related generally to machine learning involving data and in particular to a system and method for selecting between different machine learning methods and optimizing the parameters that control their behavior.

2. Description of Related Art

With the fast development in science and engineering, people who analyze data are faced with more and more models and algorithms to choose from, and almost all of them are highly parameterized. In order to obtain satisfactory performance, an appropriate model and/or algorithm with optimized parameter settings has to be carefully selected based on the given dataset, and solving this high dimensional optimization problem has become a challenging task.

One commonly used parameter tuning method is grid search, which conducts an exhaustive search in a confined domain for each parameter. However, this traditional method is restricted to tuning over parameters within one model, and can be extremely computationally intensive when tuning more than one parameter, as is typically necessary for the best-performing models on the largest datasets, which typically have dozens if not more parameters. Additionally, the statistical performance of grid search is highly sensitive to user input, e.g. the searching range and the step size. This makes grid search unapproachable for non-expert users, who may conclude that a particular machine learning method is inferior when actually they have just misjudged the appropriate ranges for one or more of its parameters. To alleviate these drawbacks, researchers have proposed techniques such as iterative refinement, which can accelerate the tuning process to some extent, but unfortunately still requires input from users and is not efficient enough for high dimensional cases. Random search is another popular method, but its performance is also sensitive to the initial setting and the dataset. Regardless, neither of these two techniques can effectively help select from among different models and/or algorithms.

Recently, researchers have proposed another type of method, model-based parameter tuning, which has shown to outperform traditional methods on high dimensional problems. Previous work on model based tuning method includes the tree-structured Parzen estimator (TPE), proposed by Bergstra, J. S., Bardenet, R., Bengio, Y., and Kégl, B., “Algorithms for hyper-parameter optimization,” Advances in Neural Information Processing Systems, 2546-2554 (2011), and sequential model-based algorithm configuration (SMAC), proposed by Hutter, F., Hoos, H. H., and Leyton-Brown, K., “Sequential model-based optimization for general algorithm configuration,” Learning and Intelligent Optimization, Springer Berlin Heidelberg, 507-523 (2011). Thornton, C., Hutter, F., Hoos, H. H., and Leyton-Brown, K., “Auto-WEKA: Combined selection and hyperparameter optimization of classification algorithms,” Proceedings of the 19th ACM SIGKDD international conference on Knowledge discovery and data mining, ACM, 847-855 (2013) has combined the work in the above papers and applied different techniques for tuning classification algorithms implemented in Waikato Environment for Knowledge Analysis (WEKA). However, this model is restricted to the classification task on small datasets, and it does not allow users to specify and configure the tuning space for a specific task.

Thus, there is a need for a system and method that selects between different machine learning methods and optimizing the parameters that control their behavior.

### SUMMARY OF THE INVENTION

The present invention overcomes one or more of the deficiencies of the prior art at least in part by providing a system and method for selecting between different machine learning methods and optimizing the parameters that control their behavior.

According to one innovative aspect of the subject matter described in this disclosure, a system comprises: one or more processors; and a memory storing instructions that, when executed by the one or more processors, cause the system to: receive data; determine a first candidate machine learning method; tune one or more parameters of the first candidate machine learning method; determine that the first candidate machine learning method and a first parameter configuration for the first candidate machine learning method are the best based on a measure of fitness subsequent to satisfaction of a stop condition; and output the first candidate machine learning method and the first parameter configuration for the first candidate machine learning method.

In general, another innovative aspect of the subject matter described in this disclosure may be embodied in methods that include receiving data; determining, using one or more processors, a first candidate machine learning method; tuning, using one or more processors, one or more parameters of the first candidate machine learning method; determining, using one or more processors, that the first candidate machine learning method and a first parameter configuration for the first candidate machine learning method are the best based on a measure of fitness subsequent to satisfaction of a stop condition; and outputting, using one or more processors, the first candidate machine learning method and the first parameter configuration for the first candidate machine learning method.

Other aspects include corresponding methods, systems, apparatus, and computer program products. These and other implementations may each optionally include one or more of the following features.

For instance, the operations further include: determining a second machine learning method; tuning, using one or more processors, one or more parameters of the second candidate machine learning method, the second candidate machine learning method differing from the first candidate machine learning method; and wherein the determination that the first candidate machine learning method and the first parameter configuration for the first candidate machine learning method are the best based on the measure of fitness includes determining that the first candidate machine learning method and the first parameter configuration for the first candidate machine learning method provide superior performance with regard to the measure of fitness when compared to the second candidate machine learning method with the second parameter configuration.

For instance, the features include: the tuning of the one or more parameters of the first candidate machine learning method is performed using a first processor of the one or more processors and the tuning of the one or more parameters of the second candidate machine learning method is performed using a second processor of the one or more processors in parallel with the tuning of the first candidate machine learning method.

For instance, the features include: a first processor of the one or more processors alternates between the tuning the one or more parameters of the first candidate machine learning method and the tuning of the one or more parameters of the second candidate machine learning method.

For instance, the features include: a greater portion of the resources of the one or more processors is dedicated to tuning the one or more parameters of the first candidate machine learning method than to tuning the one or more parameters of the second candidate machine learning method based on tuning already performed on the first candidate machine learning method and the second candidate machine learning method, the tuning already performed indicating that the first candidate machine learning method is performing better than the second machine learning method based on the measure of fitness.

For instance, the features include: the user specifies the data, and wherein the first candidate machine learning method and the second machine learning method are selected and the tunings and determination are performed automatically without user-provided information or with user-provided information.

For instance, the features include tuning the one or more parameters of the first candidate machine learning method further comprising: setting a prior parameter distribution; generating a set of sample parameters for the one or more parameters of the first candidate machine learning method based on the prior parameter distribution; forming a new parameter distribution based on the prior parameter distribution and the previously generated set of sample parameters for each of the one or more parameters of the first candidate; generating a new set of sample parameters for the one or more parameters of the first candidate machine learning method.

For instance, the operations further include: determining the stop condition is not met; setting the new parameter distribution as the previously learned parameter distribution and setting the new set of sample parameters as the previously generated set of sample parameters; and repeatedly forming a new parameter distribution based on the previously learned parameter distribution and the previously generated sample parameters for each of the one or more parameters of the first candidate machine learning method, generating a new set of sample parameters for the one or more parameters of the first candidate machine learning method, setting the new parameter distribution as the previously learned parameter distribution and setting the new set of sample parameters as the previously generated set of sample parameters before the stop condition is met.

For instance, the features include: one or more of the determination of the first candidate tuning method and the tuning of the one or more parameters of the first candidate machine learning method are based on a previously learned parameter distribution.

For instance, the features include: the received data includes at least a portion of a Big Data data set and wherein the tuning of the one or more parameters of the first candidate machine learning method is based on the Big Data data set.

Advantages of the system and method described herein may include, but are not limited to, automatic selection of a machine learning method and optimized parameters from among multiple possible machine learning methods, parallelization of tuning one or more machine learning methods and associated parameters, selection and optimization of a machine learning method and associated parameters using Big Data, using a previous distribution to identify one or more of a machine learning method and one or more parameter configurations likely to perform well based on a measure of fitness, executing any of the preceding for a novice user and allowing an expert user to utilize his/her domain knowledge to modify the execution of the preceding.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram of an example system for machine learning method selection and parameter optimization according to one implementation.

FIG. 2 is a block diagram of an example of a selection and optimization server according to one implementation.

FIG. 3 is a flowchart of an example method for a parameter optimization process according to one implementation.

FIG. 4 is a flowchart of an example method for a machine learning method selection and parameter optimization process according to one implementation.

FIG. 5 is a graphical representation of example input options available to users of the system and method according to one implementation.

FIG. 6 is a graphical representation of an example user interface for receiving user inputs according to one implementation.

FIGS. 7a and b are illustrations of an example hierarchical relationship between parameters according to one or more implementations.

FIG. 8 is a graphical representation of an example user interface for output of the machine learning method selection and parameter optimization process according to one implementation.

### DETAILED DESCRIPTION

One or more of the deficiencies of existing solutions noted in the background are addressed by the disclosure herein. In the below description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one implementation below with reference to particular hardware and software implementations. However, the present invention applies to other types of implementations distributed in the cloud, over multiple machines, using multiple processors or cores, using virtual machines, appliances or integrated as a single machine.

Reference in the specification to “one implementation” or “an implementation” means that a particular feature, structure, or characteristic described in connection with the implementation is included in at least one implementation of the invention. The appearances of the phrase “in one implementation” in various places in the specification are not necessarily all referring to the same implementation. In particular the present invention is described below in the context of multiple distinct architectures and some of the components are operable in multiple architectures while others are not.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Furthermore, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described without reference to any particular programming language. It will be appreciated that a variety of programming languages may be used to implement the teachings of the invention as described herein.

A system and method for selecting between different machine learning methods and optimizing the parameters that control their behavior is described. The disclosure is particularly applicable to a machine learning method selection and parameter optimization system and method implemented in a plurality of lines of code and provided in a client/server system and it is in this context that the disclosure is described. It will be appreciated, however, that the system and method has greater utility because it can be implemented in hardware (examples of which are described below in more detail), or implemented on other computer systems such as a cloud computing system, a standalone computer system, and the like and these implementations are all within the scope of the disclosure.

A method and system are disclosed for automatically and simultaneously selecting between distinct machine learning models and finding optimal model parameters for various machine learning tasks. Examples of machine learning tasks include, but are not limited to, classification, regression, and ranking. The performance can be measured by and optimized using one or more measures of fitness. The one or more measures of fitness used may vary based on the specific goal of a project. Examples of potential measures of fitness include, but are not limited to, error rate, F-score, area under curve (AUC), Gini, precision, performance stability, time cost, etc.

Unlike the traditional grid-search-based tuning method, the model-based automatic parameter tuning method described herein is able to explore the entire space formed by different models together with their associated parameters. The model-based automatic parameter tuning method described herein is further able to intelligently and automatically detect effective search directions and refine the tuning region, and hence arrive at the desired result in an efficient way. Further, unlike other previous work, the method is able to run on datasets that are too large to be stored and/or processed on a single computer, can evaluate and learn from multiple parameter configurations simultaneously, and is appropriate for users with different skill levels.

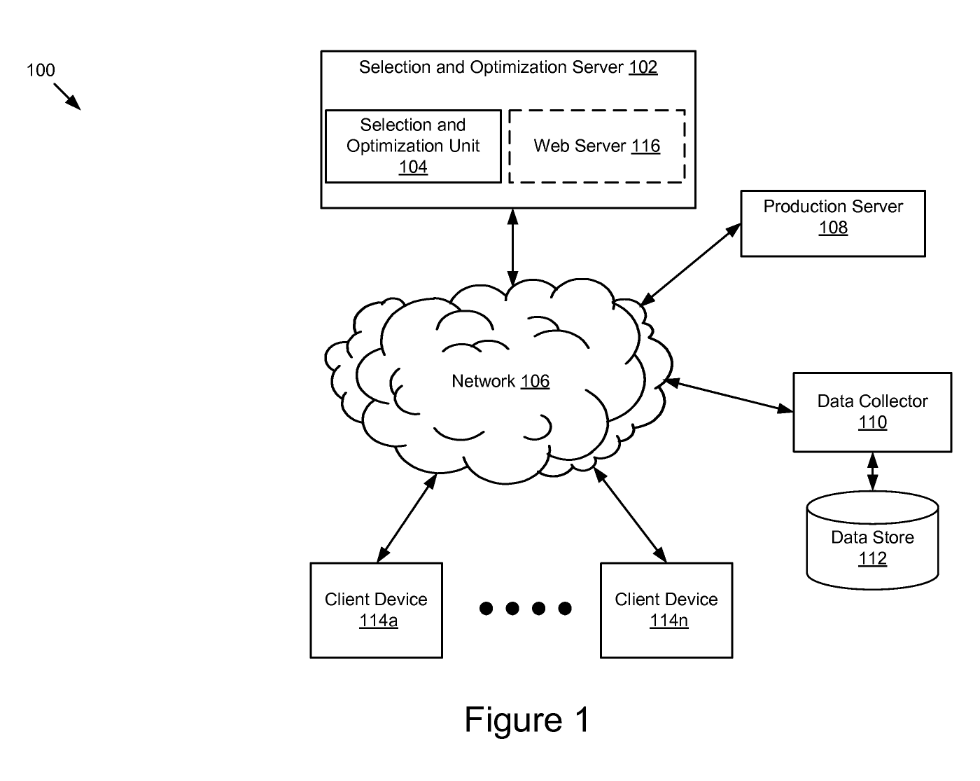

FIG. 1 shows an implementation of a system 100 for selecting between different machine learning methods and optimizing the parameters that control their behavior. In the depicted implementation, the system 100 includes a selection and optimization server 102, a plurality of client devices 114a . . . 114n, a production server 108, a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted implementation, these entities of the system 100 are communicatively coupled via a network 106.

In some implementations, the system 100 includes one or more selection and optimization servers 102 coupled to the network 106 for communication with the other components of the system 100, such as the plurality of client devices 114a . . . 114n, the production server 108, and the data collector 110 and associated data store 112. In some implementations, the selection and optimization server 102 may either be a hardware server, a software server, or a combination of software and hardware.

In some implementations, the selection and optimization server 102 is a computing device having data processing (e.g. at least one processor), storing (e.g. a pool of shared or unshared memory), and communication capabilities. For example, the selection and optimization server 102 may include one or more hardware servers, server arrays, storage devices and/or systems, etc. In some implementations, the selection and optimization server 102 may include one or more virtual servers, which operate in a host server environment and access the physical hardware of the host server including, for example, a processor, memory, storage, network interfaces, etc., via an abstraction layer (e.g., a virtual machine manager). In some implementations, the selection and optimization server 102 may optionally include a web server 116 for processing content requests, such as a Hypertext Transfer Protocol (HTTP) server, a Representational State Transfer (REST) service, or some other server type, having structure and/or functionality for satisfying content requests and receiving content from one or more computing devices that are coupled to the network 106 (e.g., the production server 108, the data collector 110, the client device 114, etc.).

In some implementations, the components of the selection and optimization server 102 may be configured to implement the selection and optimization unit 104 described in more detail below. In some implementations, the selection and optimization server 102 determines a set of one or more candidate machine learning methods, automatically and intelligently tunes one or more parameters in the set of one or more candidate machine learning methods to optimize performance (based on the one or more measures of fitness), and selects a best (based on the one or more measures of fitness) performing machine learning method and the tuned parameter configuration associated therewith. For example, the selection and optimization server 102 receives a set of training data (e.g. via a data collector 110), determines a first machine learning method and second machine learning method are candidate machine learning methods, determines the measure of fitness is AUC, automatically and intelligently tunes the parameters of the first candidate machine learning method to maximize AUC, automatically and intelligently tunes, at least in part, the parameters of the second candidate machine learning method to maximize AUC, determines that the first candidate machine learning method with its tuned parameters has a greater, maximum AUC than the second candidate machine learning method, and selects the first candidate machine learning method with its tuned parameters.

In one implementation, a model includes a choice of a machine learning method (e.g. GBM or SVM), hyperparameter settings (e.g. SVM's regularization term) and parameter settings (e.g. SVM's alpha coefficients on each data point) and the system and method herein can determine any of thes values which define a model. It should be recognized that indicators such as “first” and “second” (e.g. with regard candidate machine learning methods, parameters, processors, etc.) are used for clarity and convenience as identifiers and do not necessarily indicate an ordering in time, rank or otherwise.

Although only a single selection and optimization server 102 is shown in FIG. 1, it should be understood that there may be a number of selection and optimization servers 102 or a server cluster depending on the implementation. Similarly, it should be understood that the features and functionality of the selection and optimization server 102 may be combined with the features and functionalities of one or more other servers 108/110 into a single server (not shown).

The data collector 110 is a server/service which collects data and/or analyses from other servers (not shown) coupled to the network 106. In some implementations, the data collector 110 may be a first or third-party server (that is, a server associated with a separate company or service provider), which mines data, crawls the Internet, and/or receives/retrieves data from other servers. For example, the data collector 110 may collect user data, item data, and/or user-item interaction data from other servers and then provide it and/or perform analysis on it as a service. In some implementations, the data collector 110 may be a data warehouse or belong to a data repository owned by an organization.

The data store 112 is coupled to the data collector 110 and comprises a non-volatile memory device or similar permanent storage device and media. The data collector 110 stores the data in the data store 112 and, in some implementations, provides access to the selection and optimization server 102 to retrieve the data collected by the data store 112 (e.g. training data, response variables, rewards, tuning data, test data, user data, experiments and their results, learned parameter settings, system logs, etc.). In machine learning, a response variable, which may occasionally be referred to herein as a “response,” refers to a data feature containing the objective result of a prediction. A response may vary based on the context (e.g. based on the type of predictions to be made by the machine learning method). For example, responses may include, but are not limited to, class labels (classification), targets (general, but particularly relevant to regression), rankings (ranking/recommendation), ratings (recommendation), dependent values, predicted values, or objective values.

Although only a single data collector 110 and associated data store 112 is shown in FIG. 1, it should be understood that there may be any number of data collectors 110 and associated data stores 112. In some implementations, there may be a first data collector 110 and associated data store 112 accessed by the selection and optimization server 102 and a second data collector 110 and associated data store 112 accessed by the production server 108. In some implementations, the data collector 110 may be omitted. For example in some implementations the data store 112 may be included in or otherwise accessible to the selection and optimization server 102 (e.g. as network accessible storage or one or more storage device(s) included in the selection and optimization server 102).

In some implementations, the one or more selection and optimization servers 102 include a web server 116. The web server 116 may facilitate the coupling of the client devices 114 to the selection and optimization server 102 (e.g. negotiating a communication protocol, etc.) and may prepare the data and/or information, such as forms, web pages, tables, plots, etc., that is exchanged with each client computing device 114. For example, the web server 116 may generate a user interface to submit a set of data for processing and then return a user interface to display the results of machine learning method selection and parameter optimization as applied to the submitted data. Also, instead of or in addition to a web server 116, the selection and optimization server 102 may implement its own API for the transmission of instructions, data, results, and other information between the selection and optimization server 102 and an application installed or otherwise implemented on the client device 114.

The production server 108 is a computing device having data processing, storing, and communication capabilities. For example, the production server 108 may include one or more hardware servers, server arrays, storage devices and/or systems, etc. In some implementations, the production server 108 may include one or more virtual servers, which operate in a host server environment and access the physical hardware of the host server including, for example, a processor, memory, storage, network interfaces, etc., via an abstraction layer (e.g., a virtual machine manager). In some implementations, the production server 108 may include a web server (not shown) for processing content requests, such as a Hypertext Transfer Protocol (HTTP) server, a Representational State Transfer (REST) service, or some other server type, having structure and/or functionality for satisfying content requests and receiving content from one or more computing devices that are coupled to the network 106 (e.g., the selection and optimization server 102, the data collector 110, the client device 114, etc.). In some implementations, the production server 108 may receive the selected machine learning method with the optimized parameters for deployment and deploy the selected machine learning method with the optimized parameters (e.g. on a test dataset in batch mode or online for data analysis).

The network 106 is a conventional type, wired or wireless, and may have any number of different configurations such as a star configuration, token ring configuration, or other configurations known to those skilled in the art. Furthermore, the network 106 may comprise a local area network (LAN), a wide area network (WAN) (e.g., the Internet), and/or any other interconnected data path across which multiple devices may communicate. In one implementation, the network 106 may include a peer-to-peer network. The network 106 may also be coupled to or include portions of a telecommunications network for sending data in a variety of different communication protocols. In some instances, the network 106 includes Bluetooth communication networks or a cellular communications network. In some instances, the network 106 includes a virtual private network (VPN).

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 (e.g. the selection and optimization server 102) via the network 106 using a wireless and/or wired connection.

A plurality of client devices 114a . . . 114n are depicted in FIG. 1 to indicate that the selection and optimization server 102 may communicate and interact with a multiplicity of users on a multiplicity of client devices 114a . . . 114n. In some implementations, the plurality of client devices 114a . . . 114n may include a browser application through which a client device 114 interacts with the selection and optimization server 102, may include an application installed enabling the device to couple and interact with the selection and optimization server 102, may include a text terminal or terminal emulator application to interact with the selection and optimization server 102, or may couple with the selection and optimization server 102 in some other way. In the case of a standalone computer embodiment of the machine learning method selection and parameter optimization system 100, the client device 114 and selection and optimization server 102 are combined together and the standalone computer may, similar to the above, generate a user interface either using a browser application, an installed application, a terminal emulator application, or the like.

Examples of client devices 114 may include, but are not limited to, mobile phones, tablets, laptops, desktops, terminals, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different implementations of the system 100. In a first example, the selection and optimization server 102, the data collector 110, and the production server 108 may each be dedicated devices or machines coupled for communication with each other by the network 106. In a second example, two or more of the servers 102, 110, and 108 may be combined into a single device or machine (e.g. the selection and optimization server 102 and the production server 108 may be included in the same server). In a third example, any one or more of the servers 102, 110, and 108 may be operable on a cluster of computing cores in the cloud and configured for communication with each other. In a fourth example, any one or more of one or more servers 102, 110, and 108 may be virtual machines operating on computing resources distributed over the internet. In a fifth example, any one or more of the servers 102, 110, and 108 may each be dedicated devices or machines that are firewalled or completely isolated from each other e.g., the servers 102 and 108 may not be coupled for communication with each other by the network 106).

While the selection and optimization server 102 and the production server 108 are shown as separate devices in FIG. 1, it should be understood that in some implementations, the selection and optimization server 102 and the production server 108 may be integrated into the same device or machine. While the system 100 shows only one device 102, 106, 108, 110 and 112 of each type, it should be understood that there could be any number of devices of each type. For example, in one embodiment, the system includes multiple selection and optimization servers 102.

Moreover, it should be understood that some or all of the elements of the system 100 could be distributed and operate in the cloud using the same or different processors or cores, or multiple cores allocated for use on a dynamic as needed basis. Furthermore, it should be understood that the selection and optimization server 102 and the production server 108 may be firewalled from each other and have access to separate data collectors 110 and associated data store 112. For example, the selection and optimization server 102 and the production server 108 may be in a network isolated configuration.

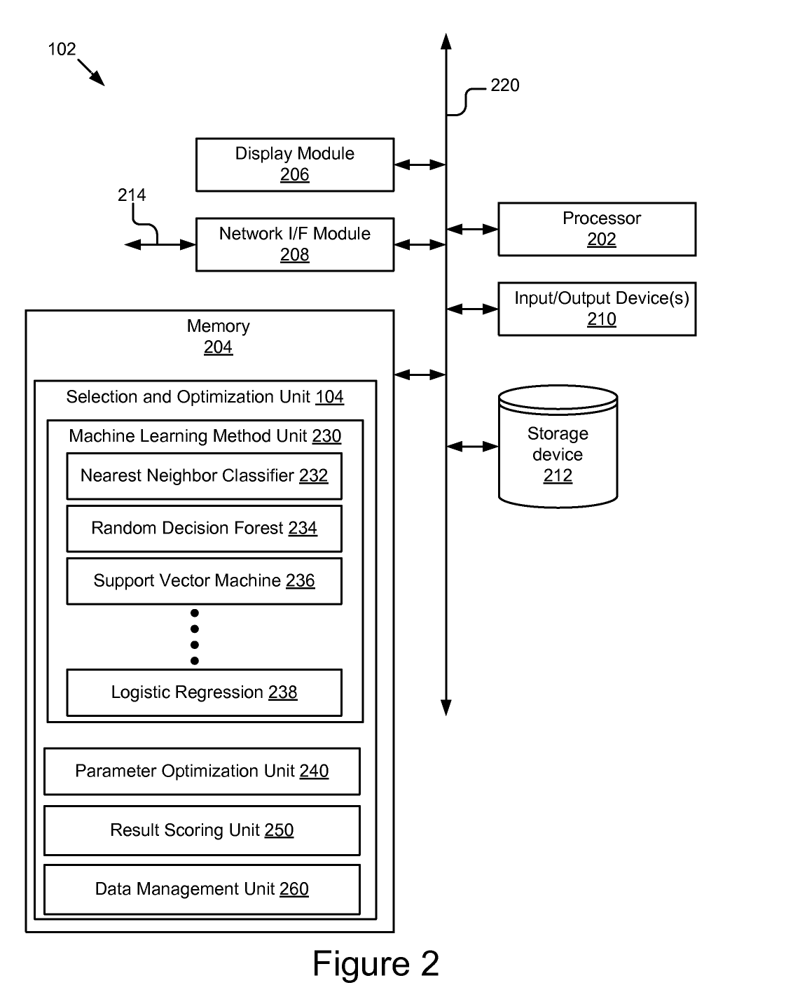

Referring now to FIG. 2, an example implementation of a selection and optimization server 102 is described in more detail. The illustrated selection and optimization server 102 comprises a processor 202, a memory 204, a display module 206, a network I/F module 208, an input/output device 210, and a storage device 212 coupled for communication with each other via a bus 220. The selection and optimization server 102 depicted in FIG. 2 is provided by way of example and it should be understood that it may take other forms and include additional or fewer components without departing from the scope of the present disclosure. For instance, various components may be coupled for communication using a variety of communication protocols and/or technologies including, for instance, communication buses, software communication mechanisms, computer networks, etc. While not shown, the selection and optimization server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays, and physical configurations are possible. In some implementations, the processor(s) 202 may be coupled to the memory 204 via the bus 220 to access data and instructions therefrom and store data therein. The bus 220 may couple the processor 202 to the other components of the selection and optimization server 102 including, for example, the display module 206, the network I/F module 208, the input/output device(s) 210, and the storage device 212.

The memory 204 may store and provide access to data to the other components of the selection and optimization server 102. The memory 204 may be included in a single computing device or a plurality of computing devices. In some implementations, the memory 204 may store instructions and/or data that may be executed by the processor 202. For example, as depicted in FIG. 2, the memory 204 may store the selection and optimization unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of selection and optimization server 102.

The instructions stored by the memory 204 and/or data may comprise code for performing any and/or all of the techniques described herein. The memory 204 may be a dynamic random access memory (DRAM) device, a static random access memory (SRAM) device, flash memory, or some other memory device known in the art. In some implementations, the memory 204 also includes a non-volatile memory such as a hard disk drive or flash drive for storing information on a more permanent basis. The memory 204 is coupled by the bus 220 for communication with the other components of the selection and optimization server 102. It should be understood that the memory 204 may be a single device or may include multiple types of devices and configurations.

The display module 206 may include software and routines for sending processed data, analytics, or results for display to a client device 114, for example, to allow a user to interact with the selection and optimization server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS, and SMTP as will be understood to those skilled in the art. In an alternate implementation, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MMS), hypertext transfer protocol (HTTP), direct data connection, wireless access protocol (WAP), email, etc. In still another implementation, the network I/F module 208 includes ports for wired connectivity such as but not limited to universal serial bus (USB), secure digital (SD), CAT-5, CAT-5e, CAT-6, fiber optic, etc.

The input/output device(s) (“I/O devices”) 210 may include any device for inputting or outputting information from the selection and optimization server 102 and can be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions in the selection and optimization server 102. An output device may be any device or mechanism of outputting information from the selection and optimization server 102, for example, it may indicate status of the selection and optimization server 102 such as: whether it has power and is operational, has network connectivity, or is processing transactions.

The storage device 212 is an information source for storing and providing access to data, such as a plurality of datasets. The data stored by the storage device 212 may be organized and queried using various criteria including any type of data stored by it. The storage device 212 may include data tables, databases, or other organized collections of data. The storage device 212 may be included in the selection and optimization server 102 or in another computing system and/or storage system distinct from but coupled to or accessible by the selection and optimization server 102. The storage device 212 can include one or more non-transitory computer-readable mediums for storing data. In some implementations, the storage device 212 may be incorporated with the memory 204 or may be distinct therefrom. In some implementations, the storage device 212 may store data associated with a relational database management system (RDBMS) operable on the selection and optimization server 102. For example, the RDBMS could include a structured query language (SQL) RDBMS, a NoSQL RDBMS, various combinations thereof, etc. In some instances, the RDBMS may store data in multi-dimensional tables comprised of rows and columns, and manipulate, e.g., insert, query, update, and/or delete rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the selection and optimization server 102. The bus 220 can include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the selection and optimization server 102 (operating systems, device drivers, etc.), and any of the components of the selection and optimization unit 104 may cooperate and communicate via a communication mechanism included in or implemented in association with the bus 220. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the selection and optimization unit 104 may include and may signal the following to perform their functions: a machine learning method unit 230, a parameter optimization unit 240, a result scoring unit 250, and a data management unit 260. These components 230, 240, 250, 260, and/or components thereof, may be communicatively coupled by the bus 220 and/or the processor 202 to one another and/or the other components 206, 208, 210, and 212 of the selection and optimization server 102. In some implementations, the components 230, 240, 250, and/or 260 may include computer logic (e.g., software logic, hardware logic, etc.) executable by the processor 202 to provide their acts and/or functionality. In any of the foregoing implementations, these components 230, 240, 250, and/or 260 may be adapted for cooperation and communication with the processor 202 and the other components of the selection and optimization server 102.

For clarity and convenience, the disclosure will occasionally refer to the following example scenario and system: assume that a user desires to classify e-mail as spam or not spam; also, assume that the data includes e-mails correctly labeled as spam or not spam, the labels (“spam” and “not spam”) and some tuning data; furthermore, assume that the system 100 supports only two machine learning methods—support vector machines (SVM) and gradient boosted machines (GBM); additionally, assume that the user desires the machine learning method and parameter setting that results in the greatest accuracy. However, it should be recognized that this example is merely one example and that other examples and implementations which may perform different tasks (e.g. rank instead of classify), have different data (e.g. different labels), support a different number of machine learning methods and/or different machine learning methods, etc.

The parameter optimization unit 240 includes logic executable by the processor 202 to generate parameters for a machine learning technique. For example, the parameter optimization unit generates a value for each of the parameters of a machine learning technique.

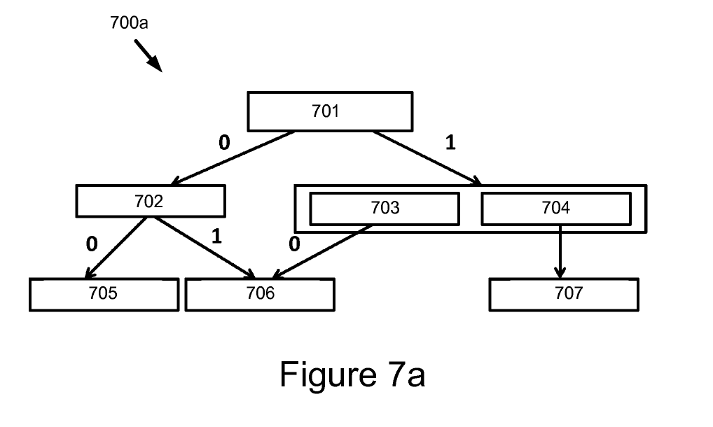

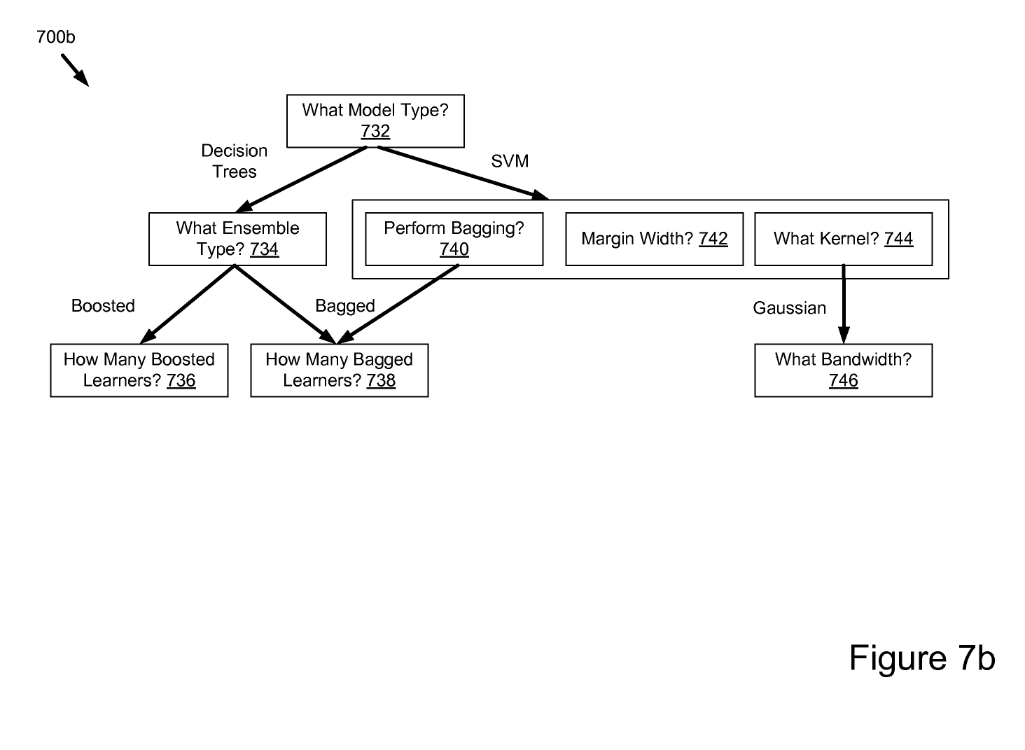

In one implementation, the parameter optimization unit 240 determines the parameters to be generated. In one implementation, the parameter optimization unit 240 uses a hierarchical structure to determine one or more parameters (which may include the one or more candidate methods). Examples of hierarchical structures are discussed below with reference to FIGS. 7a and 7b.

In one implementation, the parameter optimization unit 240 determines a set of candidate machine learning methods. For example, the parameter optimization unit 240 determines that the candidate machine learning techniques are SVM and GBM automatically (e.g. by determining based on the received data, user input, or other means that the user's problem is one of classification and eliminating any machine learning methods that cannot perform classification, such as those that exclusively perform regression or ranking)

In one embodiment, the parameter optimization unit 240 determines one or more parameters associated with a candidate machine learning method. For example, when the parameter optimization unit 240 determines that SVM is a candidate machine learning method, the parameter optimization unit 240 determines whether to use a Gaussian, polynomial or linear kernel (first parameter), a margin width (second parameter), and whether to perform bagging (a third parameter). In one implementation, the parameter optimization unit 240 uses a hierarchical structure similar to those discussed below with regard to FIGS. 7a and 7b to determine one or more of a candidate machine learning method and the one or more parameters used thereby.

In one implementation, the parameter optimization unit 240 sets a prior parameter distribution. The basis of the prior parameter distribution may vary based on one or more of the implementations, the circumstances or user input. For example, assume the user is an expert in the field and has domain knowledge that 1,000-2,000 trees typically yields good results and provides input to the system 100 including those bounds; in one implementation, the parameter optimization unit 240 receives those bounds and sets that as the prior distribution for the parameter associated with the number of trees in a decision tree model based on the user's input. In another example, assume that 1,000-2,000 trees typically yields good results; in one implementation, the system may include a default setting constraining the number of trees in a decision tree model and the parameter optimization unit 240 obtains that default setting and sets the prior distribution for the parameter associated with the number of trees in a decision tree model based on the default setting. In another example, assume the user has previously, partially tuned (e g tuning was interrupted) or tuned to completion (e.g. the model was previously trained on older e-mail data and the user wants an updated model trained on data that includes new data or another model was trained on other data) the one or more parameters; in one implementation, the parameter optimization unit 240 sets the prior distribution based on the previous tuning, which may also be referred to occasionally as “a previously learned parameter distribution(s)” or similar.

The parameter optimization unit 240 generates one or more parameters based on the prior parameter distribution. A parameter generated by the parameter optimization unit 240 is occasionally referred to as a “sample” parameter. In one embodiment, the parameter optimization unit 240 generates one or more parameters randomly based on the prior parameter distribution. For example, in one implementation, the parameter optimization unit 240 randomly (or using a log normal distribution, depending on the implementation) selects a number of trees between 1,000 and 2,000 (based on the example prior distribution above) X times, where X is a number that may be set by the user and/or as a system 100 default. For example, assume for simplicity that X is 2 and the parameter optimization unit 240 randomly generated 1437 trees and 1293 trees. Also for simplicity, this example ignores other potential parameters that may exist for GBM, for example, tree depth, which will undergo a similar process (e.g. a first random tree depth may be generated and paired with the 1437 tree parameter and a second random tree depth may be generated and paired with the 1293 tree parameter).

The one or more sample parameters (whether based on a prior distribution or new distribution) are made available to the machine learning method unit 230 which implements the corresponding machine learning method (e.g. GBM) using the one or more sample parameters based on the prior distribution (e.g. 1437 and 1293). Depending on the implementation, the parameter optimization unit 240 may send the one or more sample parameters to the machine learning method unit 230 or store the one or more sample parameters and the machine learning method unit 230 may retrieve the one or more sample parameters from storage (e.g. storage device 212).

In one implementation, the machine learning method unit 230 (described further below) implements the corresponding machine learning method (e.g. GBM) using the one or more parameters. For example, the machine learning method unit 230 implements GBM with 1437 trees, and then implements GBM with 1293 trees. In one implementation, the result scoring unit 250 (described further below) uses a measure of fitness to score the results of each parameter configuration. For example, assume the measure of fitness is accuracy and the result scoring unit 250 determines that GBM with 1293 trees has an accuracy of 0.91 and GBM with 1437 trees has an accuracy of 0.94.

In one implementation, the parameter optimization unit 240 receives feedback from the result scoring unit 250. For example, in one embodiment, the parameter optimization unit 240 receives the measure of fitness associated with each configuration of the one or more parameters of a machine learning method generated by the parameter optimization unit 240.

In one embodiment, the parameter optimization unit 240 uses the feedback to form a new parameter distribution. For example, the parameter optimization unit 240 forms a new parameter distribution where the number of trees is between 1,350 and 2,100.

In one implementation, the parameter optimization unit 240 forms a new distribution statistically favoring successful (determined by the measure of fitness) parameter values and biasing against parameter values that performed poorly. In one implementation, the parameter optimization unit 240 randomly generates a plurality of sample configurations for the one or more parameters based on the new parameter distribution, ranks the configurations based on the potential to increase the measure of fitness, and provides the highest ranking parameter configuration to the machine learning method unit 230 for implementation. To summarize and simplify, the parameter optimization unit 240 may modify limits, variances, and other statistical values and/or select a parameter configuration based on past experience (i.e. the scores associated with previous parameter configurations). It should be recognized that the distributions and optimization of a parameter (e.g. a number of trees) with regard to a first candidate machine learning candidate (e.g. GBM) may be utilized in the tuning of a second candidate machine learning method (e.g. random decision forest) and may expedite the selection of a machine learning method and optimal parameter configuration.

The parameter optimization unit 240 generates one or more parameters based on the new parameter distribution. In one implementation, the parameter optimization unit 240 generates one or more parameters randomly based on the new parameter distribution. For example, in one implementation, the parameter optimization unit 240 randomly (or using a log normal distribution, depending on the implementation) selects a number of trees between 1,350 and 2,100 (based on the example prior distribution above) Y times, where Y is a number that may be set by the user and/or as a system 100 default and, depending on the implementation, may be the same as X or different. For example, assume for simplicity that Y is 2 and the parameter optimization unit 240 randomly generated 2037 trees and 1391 trees. Also for simplicity, this example ignores other potential parameters that may exist for GBM, for example, tree depth, which will undergo a similar process (e.g. a first random tree depth may be generated and paired with the 2037 tree parameter and a second random tree depth may be generated and paired with the 1391 tree parameter).

In one implementation, the machine learning method unit 230 (described further below) implements the corresponding machine learning method (e.g. GBM) using the one or more parameters. For example, the machine learning method unit 230 implements GBM with 2037 trees, and then implements GBM with 1391 trees. In one implementation, the result scoring unit 250 (described further below) uses a measure of fitness to score the results of each parameter configuration. For example, assume the measure of fitness is accuracy and the result scoring unit 250 determines that GBM with 1391 trees has an accuracy of 0.89 and GBM with 2037 trees has an accuracy of 0.92.

The parameter optimization unit 240 may then receive this feedback from the result scoring engine and repeat the process of forming a new parameter distribution and generating one or more new sample parameters to be implemented by the machine learning method unit and scored based on the one or more measures of fitness by the result scoring unit 250. When forming a new parameter distribution is repeated, in one implementation, the preceding new parameter distribution is an example of a previously learned parameter distribution, and depending on the implementation may be used as a “checkpoint” to restart a tuning where it left off due to an interruption.

In one embodiment, the parameter optimization unit 240 repeats the process of forming a new parameter distribution and generating one or more new sample parameters to be implemented by the machine learning method unit and scored based on the one or more measures of fitness by the result scoring unit 250 until one or more stop conditions are met. In some implementations, the stop condition is based on one or more thresholds. Examples of a stop condition based on a threshold include, but are not limited to, a number of iterations, an amount of time, CPU cycles, number of iterations since a better measure of fitness has been obtained, a number of iterations without the measure of fitness increasing by a certain amount or percent (e.g. reaching a steady state), etc.

In some implementations, the stop condition is based on a determination that another machine learning method is outperforming the present machine learning method and the present machine learning method is unlikely to close the performance gap. For example, assume the highest accuracy achieved by a SVM model is 0.57; in one implementation, the parameter optimization unit 240 determines that it is unlikely that a parameter configuration for SVM will come close to competing with the 0.8-0.94 accuracy of the GBM in the example above and stops tuning the parameters for the SVM model.

The one or more criteria used by the parameter optimization unit 240 to determine whether a machine learning method is likely to close the performance gap between it and another candidate machine learning method may vary based on the implementation. Examples of criteria include the size of the performance gap (e.g. a performance gap of sufficient magnitude may trigger a stop condition), the number of iterations performed (e.g. more likely to trigger a stop condition the more iterations have occurred as it indicates that more of the tuning space has been explored and a performance gap remains), etc. Such implementations may beneficially preserve computational resources by eliminating machine learning methods and associated tuning computations when it is unlikely that the machine learning method will provide the “best” (as defined by the observed measure of fitness) model.

In some implementations, the system alternates between parameter configurations for different machine learning methods throughout the tuning process without the need for intermediate stopping conditions. Some implementations accomplish this by implementing the choice of machine learning method itself as a categorical parameter; as such, the parameter optimization unit 240 generates a sequence of parameter configurations for differing machine learning methods by randomly selecting the machine learning method from the set of candidate machine learning methods according to a learned distribution of well-performing machine learning methods. This is completely analogous to how the parameter optimization unit 204 selects values for other parameters by randomly sampling from learned distributions of well-performing values for those parameters. As a result, the parameter optimization unit 240 automatically learns to avoid poorly performing machine learning methods, sampling them less frequently, because these will have a lower probability in the learned distribution of well-performing machine learning methods. At the same time, the parameter optimization unit 240 automatically learns to favor well-performing machine learning methods, sampling them more frequently, because these will have a higher probability in the learned distribution of well-performing machine learning methods. In one such implementation, the parameter optimization unit 240 does not ‘give up on’ and stop tuning a candidate machine learning model based on a performance gap. For example, assume the highest accuracy achieved by a SVM model is 0.57 while the highest accuracy achieved using GBM is 0.79; in one implementation, the parameter optimization unit 240 determines that it is unlikely based on the tuning performed so far that a parameter configuration for SVM will compete with the accuracy of GBM and generates sample parameters for the SVM model at a lower frequency than it generates samples for the GBM model, so tuning of the SVM continues but at a slower rate in order to provide greater resources to the more promising GBM model, until a stop condition is reached (e.g. a stop condition based on a threshold).

In one implementation, each of the candidate machine learning methods is optimized by the parameter optimization unit 240 and the best observed performing machine learning method from the set of candidate machine learning methods and associated, optimized parameter configurations is selected.

In some implementations, the selection and optimization unit 104 selects a best observed performing model from a plurality of candidate machine learning methods. In one implementation, each of the plurality of candidate machine learning methods is evaluated in parallel. For example, the system 100 includes multiple selection and optimization servers 102 and/or a selection and optimization server 102 includes multiple processors 202 and each optimization server 102 or processor thereof performs the process described herein. For example, a first selection and optimization servers 102 and/or a first processor 202 of a selection and optimization server 102 executes the example process described above for GBM and a second selection and optimization servers 102 and/or a second processor 202 of a selection and optimization server 102 executes a process similar to that described above for GBM except for the SVM machine learning method in parallel. In one such implementation, the data management unit(s) 260 manage the data produced by the process (e.g. measures of fitness) so that information for updating distributions may be shared among the multiple system 100 components (e.g. processors 202, processor cores, virtual machines, and/or selection and optimization servers 102) and so that a best observed machine learning method and parameter configuration can be selected from among the candidate machine learning methods whose processing and tuning may be distributed across multiple components (e.g. processors 202, processor cores, virtual machines, and/or selection and optimization servers 102). In one implementation, each of a plurality of processors 202, processor cores, virtual machines, and/or selection and optimization servers may alternate between tuning different machine learning method, e.g. in implementations where the machine learning method is treated as a categorical parameter that is tuned.

In one implementation, a processor 202 and/or selection and optimization server 102 may evaluate multiple machine learning methods and may switch between evaluation of a first candidate machine learning method and a second candidate machine learning method. For example, in one implementation, the processor 202 and/or selection and optimization server 102 performs one or more iterations of forming a new parameter distribution, generating new sample parameters based on the new distribution and determining whether a stop condition is met for an SVM machine learning method then the processor 202 and/or selection and optimization server 102 switches to perform one or more iterations of forming a new parameter distribution, generating new sample parameters based on the new distribution and determining whether a stop condition is met for a GBM machine learning method then switches back to the SVM machine learning method or moves to a third machine learning method.

The machine learning method unit 230 includes logic executable by the processor 202 to implementing one or more machine learning methods using parameters received from the parameter optimization unit 240. For example, the machine learning method unit 230 using analysis (e.g. k-fold cross-validation) trains a GBM machine learning model with the parameters received from the parameter optimization unit 240. The one or more machine learning methods may vary depending on the implementation. Examples of machine learning methods include, but are not limited to, a nearest neighbor classifier 232, a random decision forest 234, a support vector machine 236, a logistic regression 238, a gradient boosted machine (not shown), etc. In some implementations, for example, the one illustrated in FIG. 2, the machine learning method unit includes a unit corresponding to each supported machine learning method. For example, the machine learning method unit 230 supports SVM and GBM, and in one implementation, implements a set of SVM parameters received from the parameter optimization unit 240 by scoring tuning data (e.g. label email as either spam or not spam) using SVM and the received SVM parameters.

The result scoring unit 250 includes logic executable by the processor 202 to measure the performance of a machine learning method implemented by the machine learning method unit 230 using the one or more parameters provided by the parameter optimization unit 240. The set of parameters may occasionally be referred to herein as the “parameter configuration” or similar. In one embodiment, the result scoring unit 250 measures the performance of a machine learning method with a set of parameters using one or more measures of fitness. Examples of measures of fitness include but are not limited to error rate, F-score, area under curve (AUC), Gini, precision, performance stability, time cost, etc. For example, the result scoring unit 250 scores the accuracy of the results of the machine learning method unit's 230 implementation of an SVM model using a first set of parameters from the parameter optimization unit 240 and scores the accuracy of the results of the machine learning method unit's 230 implementation of a GBM model using a second set of parameters from the parameter optimization unit 240.

In one implementation, the result scoring unit 250 receives the one or more measures of fitness used to measure the performance of the machine learning method with a parameter configuration based on user input. For example, in one implementation, the result scoring unit 250 receives user input (e.g. via graphical user interface or command line interface) selecting Gini as the measure of fitness, and the result scoring unit 250 determines the Gini associated with the one or more candidate machine learning methods with each of the various associated parameter configurations generated by the parameter optimization unit 240.

The data management unit 260 includes logic executable by the processor 202 to manage the data used to perform the features and functionality herein, which may vary based on the implementation. For example, in one implementation, the data management unit 260 may manage chunking of one or more of input data (e.g. training data that is too large for a single selection and optimization server 102 to store and process at once such as in Big Data implementations), intermediary data (e.g. maintains parameter distributions, which may beneficially allow a user to restart tuning where the user left-off when tuning is interrupted), and output data (e.g. partial machine learning models generated across a plurality of selection and optimization servers 102, and/or processors thereof, and combined to create a global machine learning model). In one implementation, the data management unit 260 facilitates the communication of data between the various selection and optimization servers 102, and/or processors thereof in order to allow a user to restart tuning where the user left-off when tuning is interrupted), and output data (e.g. partial machine learning models generated across a plurality of selection and optimization servers 102, and/or processors thereof, and combined to create a global machine learning model).

Big Data refers to a broad collection of concepts and challenges specific to machine learning, statistics, and other sciences that deal with large amounts of data. In particular, it deals with the setting where conventional forms of analysis cannot be performed because they would take too long, exhaust computational resources, and/or fail to yield the desired results. Some example scenarios that fall under the umbrella of Big Data include, but are not limited to, datasets too large to be processed in a reasonable amount of time on a single processor core; datasets that are too big to fit in computer memory (and so must be read from e.g. disk during computation); datasets that are too big to fit on a single computer's local storage media (and so must be accessed via e.g. a remote data server); datasets that are stored in distributed file systems such as HDFS; datasets that are constantly being added to or updated, such as sensor readings, web server access logs, social network content, or financial transaction data; datasets that contain a large number of features or dimensions, which can adversely affect both the speed and statistical performance of many conventional machine learning methods; datasets that contain large amounts of unstructured or partially structured data, such as text, images, or video, which must be processed and/or cleaned before further analysis is possible; and datasets that contain large amounts of noise (random error), noisy responses (incorrect training data), outliers (notable exceptions to the norm), missing values, and/or inconsistent formatting and/or notation.

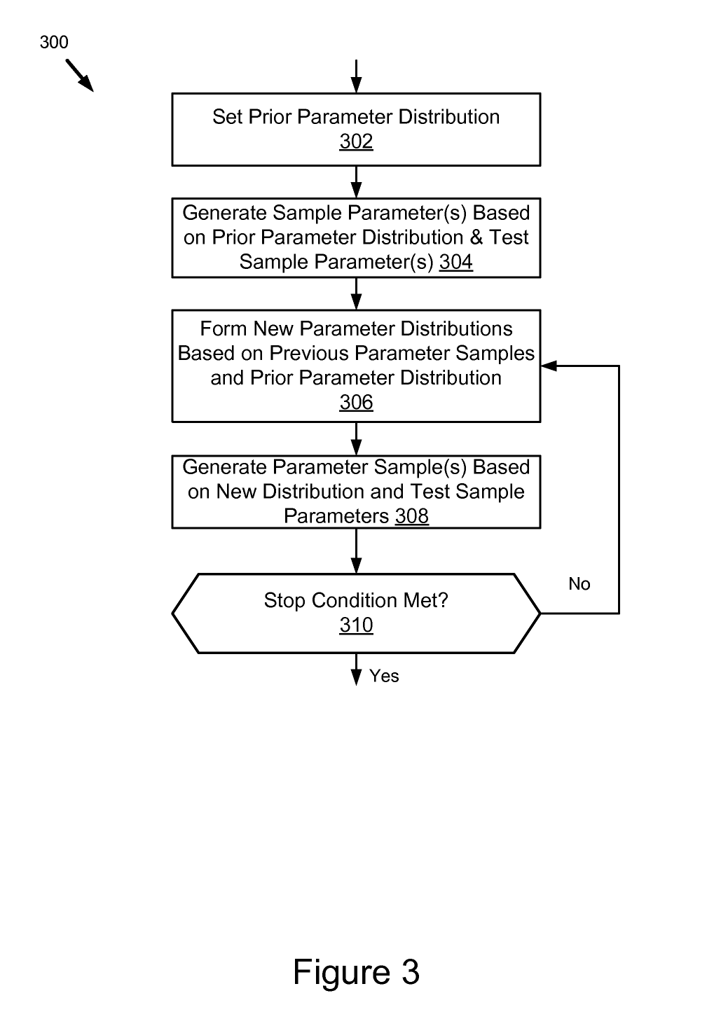

FIG. 3 is a flowchart of an example method 300 for a parameter optimization process according to one implementation. In the illustrated method 300, the method 300 begins at block 302, where the parameter optimization unit 240 sets a prior parameter distribution for a candidate machine learning method. At block 304, the parameter optimization unit 240 generates sample parameters based on the prior parameter distribution set at block 302. The appropriate component of the machine learning method unit 230 utilizes the sample parameters generated at block 304 and the parameter optimization unit 240 evaluates the performance of the candidate machine learning method using the sample parameters generated at block 304. At block 306, the parameter optimization unit 240 forms one or more new parameter distributions based on the prior parameter distribution set at block 302 and the generated sample parameter(s) generated at block 304. At block 308, the parameter optimization unit 240 generates one or more parameter samples based on the one or more new parameter distributions formed at block 306 and tests the sample parameter configurations.

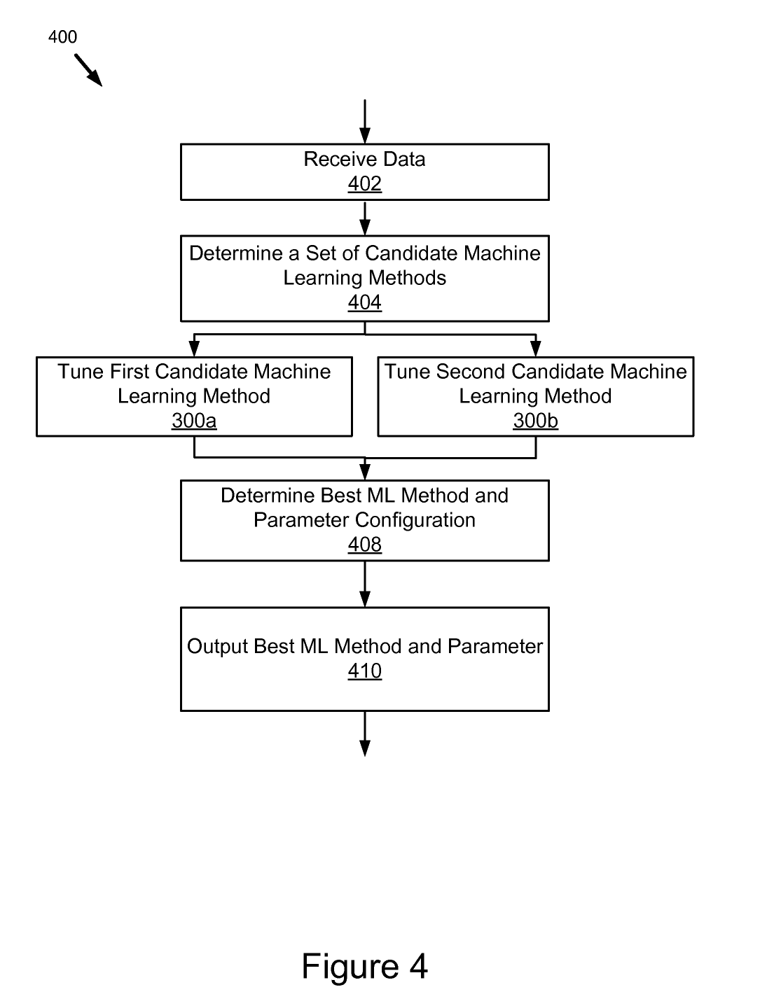

At block 310, the parameter optimization unit 240 determines whether a stop condition has been met. When a stop condition is met (310-Yes), the method 300 ends. In one embodiment, when the method 300 ends, the method 400 (referring to FIG. 4, which is described below) resumes at block 408. When a stop condition is not met (310-No), the method 300 continues at block 306 and steps 306, 308, and 310 are performed repeatedly until a stop condition is met.

FIG. 4 is a flowchart of an example method 400 for a machine learning method selection and parameter optimization process according to one implementation. In the illustrated implementation, the method 400 begins at block 402. At block 402, the data management unit 260 receives data. At block 404, machine learning method unit 230 determines a set of machine learning methods including a first candidate machine learning method and a second machine learning method.

At block 300a, the first candidate machine learning method is tuned (e.g. the method 300 described above with reference to FIG. 3 is applied to the first candidate machine learning method), and at block 300b, the second candidate machine learning method is tuned (e.g. the method 300 described above with reference to FIG. 3 is applied to the second candidate machine learning method). In the illustrated embodiment, the tuning 300a of the first candidate machine learning method and the tuning of the second candidate machine learning method may happen simultaneously (e.g. in a distributed environment). By tuning multiple machine learning methods simultaneously, which is not done by present systems, significant amounts of time may be saved and/or better results may be obtained in the same amount of time as more parameter configurations and/or machine learning methods may be evaluated to find the best machine learning method and associated parameter configuration. It should be recognized that the method 400 does not necessarily require that the first and second candidate machine learning methods be tuned to completion (i.e. to achieve the best observed measure of fitness based on the measure of fitness and stop condition). For example, the first and second candidate machine learning methods may be tuned in parallel 300a, 300b until the selection and optimization unit 104 determines that, based on the measure of fitness, the second candidate machine learning method is underperforming compared to the first candidate machine learning method and tuning of the second candidate machine learning method 300b ceases.

Referring again to FIG. 4, at block 408 the result scoring unit 250 determines the best machine learning (ML) method and associated parameter configurations. For example, the resulting scoring unit 250 compares the performance of the first candidate machine learning method with the parameter configuration that gives the first candidate machine learning the best observed performance based on the measure of fitness to the performance of the second candidate machine learning method with the parameter configuration that gives the second machine learning the best observed performance based on the measure of fitness and determines which performs better and, at block 410 outputs the best machine learning method and parameter configuration and the method ends.

It should be understood that while FIGS. 3-4 include a number of steps in a predefined order, the methods may not need to perform all of the steps or perform the steps in the same order. The methods may be performed with any combination of the steps (including fewer or additional steps) different from that shown in FIGS. 3-4. The methods may perform such combinations of steps in other orders.

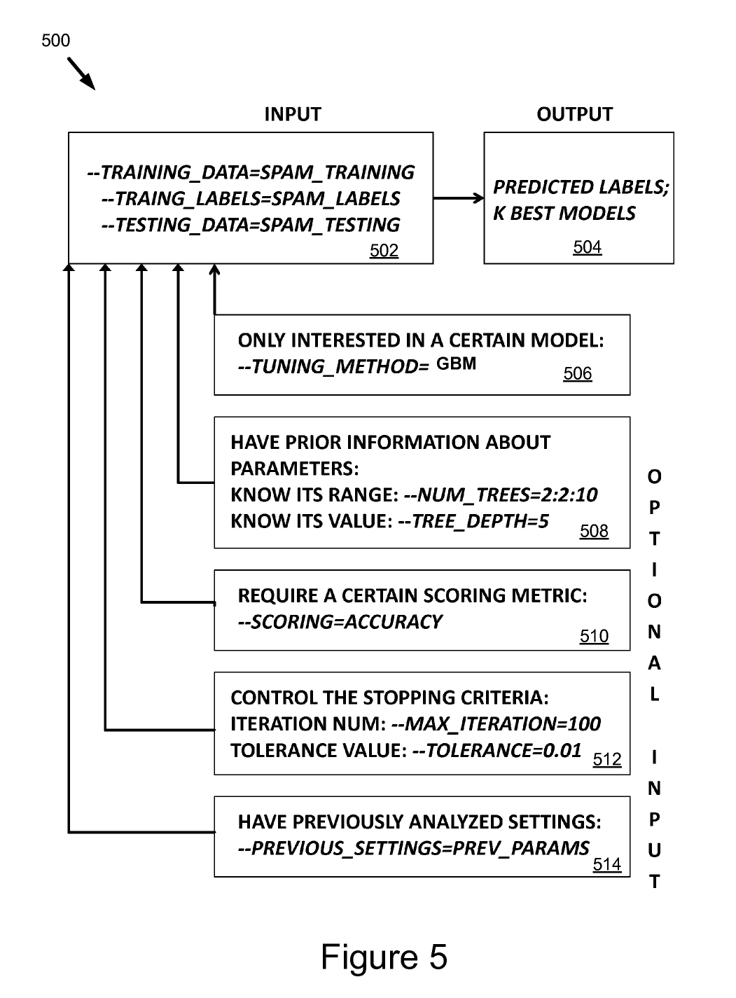

FIG. 5 is a graphical representation of example input options available to users of the system 100 and method according to one implementation. In some implementations, the machine learning method unit 230 of the selection and optimization unit includes one or more machine learning methods that rely on supervised training. In some such implementations, the selection and optimization unit 104 receives data as an input as is represented by box 502. For example, consider a classification example on spam data. Assume a user is given some emails together with their labels (spam or not) and someone would like to build a model to predict whether a new email is spam or not based on the email's features and the previous knowledge (i.e. the emails correctly labeled as spam or not which were provided to the user). Here the training data, i.e. emails with labels, may be denoted as “spam_training”, and its labels as “spam_labels”. The unlabeled emails are denoted as “spam_testing” as illustrated in block 502 of FIG. 5.

To simplify this example, the disclosure continues to discuss the system and method with regard to two classification models—gradient boosting machines (GBM) and support vector machines (SVM)—even though other and more classification, ranking, and regression models may in fact be built into the system 100. Each model is embedded with one or more parameters. For example, in GBM a proper value for the number of trees (labeled as num_trees) and the tree depth (labeled as tree_depth) need to be set, while for SVM the margin width (labeled as lambda) as well as whether to use linear SVM or nonlinear SVM (labeled as is_linear) may be considered. In the system 100, there are some other parameters associated with each model, but for clarity and convenience only the above four parameters are used in this example. In order to accomplish this task with the system, novice users only need to specify the following input: “training_data=spam_training,” “training_labels=spam_labels,” and “testing_data=spam_testing.” Such input may be provided, for example, using a graphical user interface (GUI) or a command line interface (CLI). When a user uses a command line interface to access the machine learning method selection and parameter optimization system 100, the above inputs may be formatted into a command such as:

autotune—training_data=“spam_training”—training_labels=“spam_labels”—testing_data=“spam_testing”

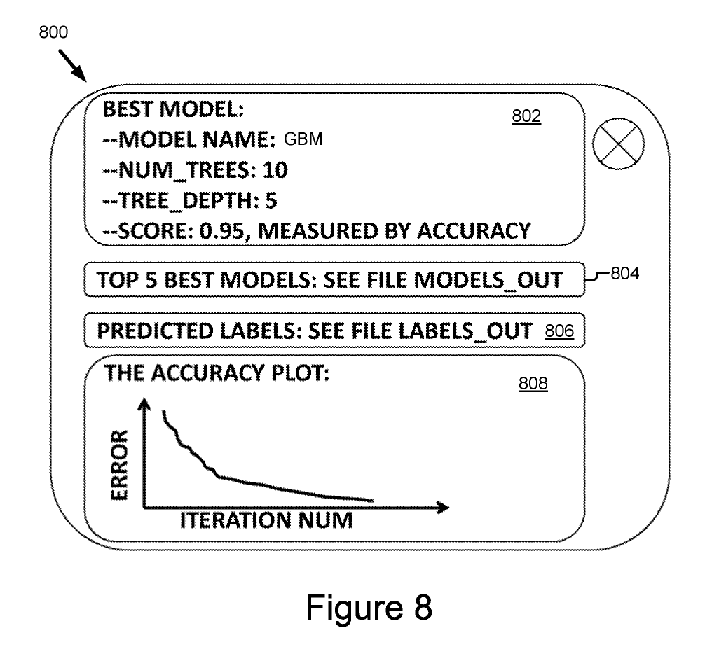

Given the above command, the system 100 automatically decides (e.g. using the methods described above with reference to FIGS. 3 and 4) which model to select (GBM or SVM) together with optimal parameter settings based on the analysis conducted on the training data, which could be, for example, k-fold cross-validation. The system 100 then outputs the predicted labels for the training and/or test data. In some implementations, the system 100 outputs the best model for presentation to the user and/or for implementation in a production environment. In some implementations, the K (e.g. default of 10) best parameter settings are available for presentation to the user. For Example, referring to FIG. 8, a graphical representation of an example user interface for output of the machine learning method selection and parameter optimization process according to one implementation is illustrated. In the Illustrated implementation, the best model (i.e. candidate machine learning method with tuned parameter set that produced the best observed measure of fitness) is presented to the user in portion 802, which identifies the best (based on accuracy as the measure of fitness) model as the GBM model, the best parameter setting to be (num_trees=10, tree_depth=5) and the best accuracy as 0.95 (i.e. best observed measure of fitness). In some implementations, the user may be presented with the option 804 to view the top K performing machine learning method and parameter configuration combinations observed. In some implementations, the user may be presented with the option 806 to view predictions made using the selected machine learning method with optimized parameter configuration. In some implementations, the user may be presented with a graphic 808 showing the gains in accuracy (or reduction in error rate) as a function of the number of iterations forming a new distribution and selecting one or more new sample parameters occurred.

In some implementations, the system 100 needs no more input from the user than specification of the data. Such implementations, may rely on default settings which are suitable for most use cases. Such implementations may provide a low barrier for entry to less skilled users and allow novice users to obtain a machine learning method with optimized parameters.

For experienced users, besides specifying the data, a user can also control the tuning process by providing user-provided information with different commands. Examples of user provided information include, but are not limited to, a limitation to a particular machine learning method, a constraint on one or more on one or more parameters (e.g. setting a single value; one or more of a minimum, a maximum, and a step size; a distribution of values, any other function which determines the value of the parameter based on additional information), setting a scoring measure of fitness, defining a stop criteria, specifying previously learned parameter settings, specifying a number and/or type of machine learning models, etc. For example, referring still to FIG. 5, box 506 illustrates a command that the user may input to limit the machine learning method or “tuning method” to GBM. Box 508 illustrates a command that the user may input to when the user knows in advance the tuning range of a certain parameter which controls the tuning space. In the instance of block 508, the values for parameter num_trees are restricted with lower bound 2, upper bound 10, and step size 2, i.e. its values can only be picked from set {2, 4, 6, 8, 10}. Note that in some implementations the users can specify the bounds without quantization or just specify one bound for the parameter. Similarly, when a user would like to fix the value for certain parameters and focus on tuning the rest, the user may set the parameter to a single value using a command similar to that for tree_depth in the box 508. When the user has a particular measure of fitness the user wants to utilize in selecting the best model (e.g. accuracy), the user may specify that using a command similar to that in block 510. The users may control when to stop the tuning process, this is occasionally referred to herein as the “stop condition,” for example, by specifying either the maximum iteration number and/or the tolerance value as illustrated in block 512. When, the user has analyzed some parameter settings before and stored them in file “prev_params,” the system 100 can utilize the information with a command such as that of box 514 to continue the tuning process from where it left off. The user may also set a number of output models (e.g. the 5 best models and their parameters).

Putting things together, a possible command entered by an experienced user could be:

autotune—training_data=“spam_training”—training_labels=“spam_labels”—testing_data=“spam_testing”—tuning_method=gbm—num_trees=2:2:10—tree_depth=5—scoring=accuracy—max_iterations=100

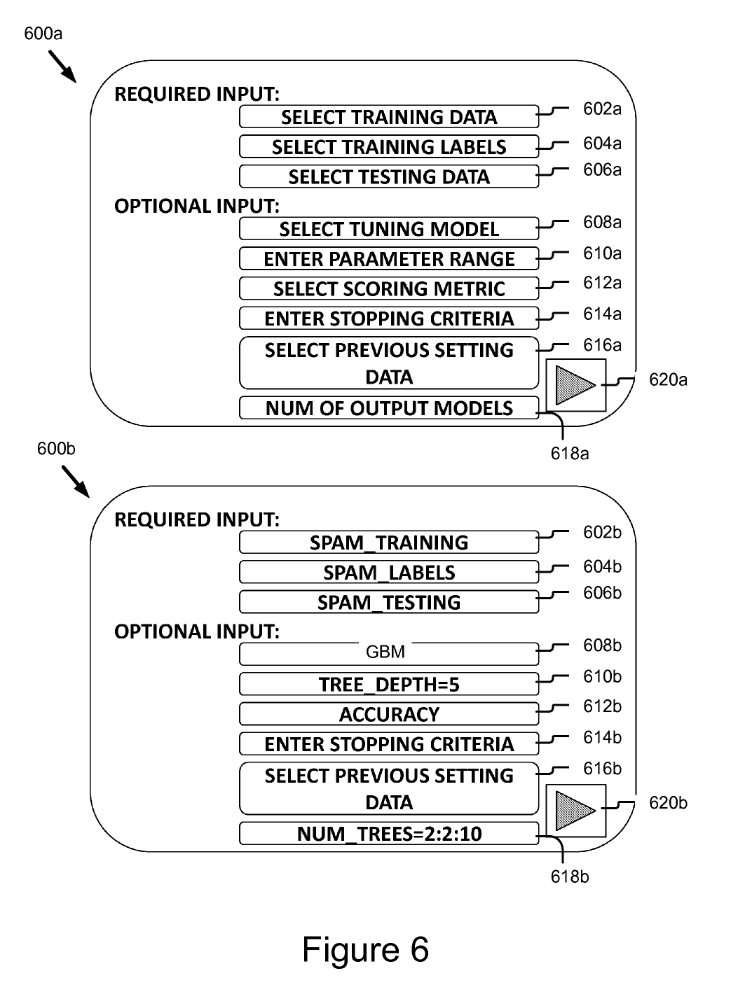

FIG. 6 is a graphical representation of an example user interface for receiving user inputs according to one implementation. The graphical user interfaces 600a and 600b provide similar functionality to that discussed above with reference to FIG. 5 and a command line interface, but using a GUI. GUI 600a shows the fields 602a, 604a, 606a, 608a, 610a 612a, 614a, 616a, 618a and what information should be input in that field should the user decide to provide that information in the case of 608a, 610a 612a, 614a, 616a, 618a. GUI 600b shows the fields of 600a populated as illustrated by 602b, 604b, 606b, 608b, 610b 612b, 614b, 616b, 618b. The output would be similar to that discussed above with reference to FIG. 8.

It should be recognized that although many of the examples used herein utilize supervised machine learning methods, these are merely used as examples and the system 100 may support one or more supervised machine learning methods, one or more unsupervised machine learning methods, one or more reinforcement machine learning methods or a combination thereof.

FIGS. 7a and 7b are illustrations of an example hierarchical relationship between parameters according to one or more implementations. FIG. 7a illustrates how a simple relation among parameters is represented with a hierarchical structure 700a. For clarity and convenience, all the parameters of FIG. 7a are categorical with a sampling space of {0, 1}. However, it should be recognized that the parameters are merely illustrative and the disclosure is not limited to categorical parameters (e.g. parameters may be numerical) and categorical parameters may have a different sampling space. In the illustrated hierarchy 700a, parameter 701 is the starting node of the structure, which means it is always generated. Parameter 702 belongs to the 0^{th} child of parameter 701, which means it is considered when parameter 701 equals 0. Similarly parameter 703 and 704 are generated when parameter 701 takes value 1. Parameter 705 is omitted from tuning under the condition that parameter 702 does not equal 0. The setting for parameter 706 denotes it is considered (e.g. tuned) in two different cases, when parameter 702 equals 1 or when parameter 703 equals 0. Lastly, the arrow from parameter 704 to parameter 707 illustrates parameter 707 is generated whenever parameter 704 is sampled.

FIG. 7b is an illustration of another implementation of a hierarchical structure 700b representing the relationships between parameters which the selection and optimization unit 104 may sample and optimize. In the illustrated example, all tuning parameters are either categorical with just two options (e.g. yes or no) or numerical. It should be recognized that these limitations are to limit the complexity of the example for clarity and convenience and not limitations of the disclosed system and method. Additionally, some parameters have been omitted for clarity and convenience (e.g. mention of a polynomial kernel option for parameter 744 and its three associated parameters to express degree, scale, and offset are not illustrated). It should be further recognized that FIG. 7b is a simplified example and that the hierarchical structure may be much larger and deeper depending on the implementation. Additionally, in some implementations, the distinction between bagged, boosted, and other kinds of methods may be incorporated directly in to the root parameter 732 because these may have a profound impact on what other parameters are available. In some implementations, the same parameter may have multiple tree nodes in mutually exclusive portions of the hierarchical structure.

Parameter 732 is the starting node of the structure and as such it is unconditionally sampled; in this case, it determines whether tuning will consider a decision tree model or a support vector machine (SVM) model. The other parameters are conditionally sampled based the value generated for parameter 732 and/or the other parameters in the structure. In particular, parameter 734, whether to perform boosting or bagging for the decision tree model, is considered when parameter 732 is generated as “Decision Trees” but otherwise not considered by the selection and optimization unit 104 for tuning. On the other hand, parameters 740 (whether or not to perform bagging for the SVM model), 742 (the margin width of the SVM, which may be a real number greater than zero), and 744 (the SVM kernel, which may be Gaussian or linear) are sampled when parameter 732 is generated as “SVM.” Further, parameter 736 (the number of boosted learners, which may be an integer greater than zero) is only sampled when parameter 734 is set to “Boosted,” and parameter 738 (the number of bagged learners, which may be an integer greater than zero) is sampled when either of parameters 734 or 740 are set to “Bagged.” Lastly, parameter 746 (the SVM Gaussian kernel bandwidth, which may be a real number greater than zero) is only sampled when parameter 744 is generated as “Gaussian.”

In some implementations, multiple generated values of the same categorical parameter can have the same parameter in their sets of follow-up parameters. The current example only shows generated values of different categorical parameters including the same parameter (738) in their sets of follow-up parameters. In some implementations, when two parameters or two generated values of the same parameter share a follow-up parameter, it is not necessary for them to share their entire parameter set. For example, root parameter 732 could have a third option, generalized linear model (GLM), which may again link to 740 (bagged or not) and 744 (choice of kernel) but not to 742 (margin width), which is SVM-specific. If fully fleshed out, GLM would also have a host of other follow-up parameters not linked to by SVM.

The machine learning method selection and parameter optimization method and system described in this disclosure beneficially supports training even with the largest datasets. Depending on the implementation, such benefits are provided by one or more of the following features of the system 100:

1. The system 100, in some implementations, supports the training, evaluation, selection, and optimization of machine learning models in the distributed computation and distributed data settings, in which many selection and optimization servers 102 can work together in order to perform simultaneous training, evaluation, selection, and optimization tasks and/or such tasks split up over multiple servers 102 working on different parts of the data.
2. The system 100, in some implementations, supports advanced algorithms that can yield fitness scores for multiple related parameter configurations at the same time. This allows the method 300 described above to learn distributions of optimal parameter configurations more quickly, and thus reduces the number of iterations and overall computation time required to select a method and tune its parameters.
3. The system 100, in some implementations, allows more advanced users to fix, constrain, and/or alter the prior distributions and distribution types of some or all of the involved parameters, including the choice of machine learning method. This allows experts to apply their domain knowledge, guiding the system away from parameter configurations known to be uninteresting or to perform poorly, and thereby helping the system to find optimal parameter configurations even more quickly.

Concerning Item 1 above, distributed computation is made possible both by (a) the observation that multiple tuning iterations may be performed independently of one another and by (b) advanced algorithms, which may or may not be proprietary, for many machine learning methods enable models pertaining to these methods to be trained and evaluated on data stored in chunks assigned to different selection and optimization servers 102. Item 1(a) may enable the system 100 to sample multiple top-ranked candidate parameter configurations to be assessed simultaneously on separate selection and optimization servers 102. The measured fitnesses may then be incorporated into the learned parameter distributions either synchronously, waiting for all selection and optimization servers 102 to finish before updating the model, or asynchronously, updating the model (and sampling a new parameter configuration) each time a selection and optimization server 102 completes an assessment, with asynchronous updates being preferred. This allows for faster exploration of the space of possible parameter configurations, ultimately reducing the time cost of machine learning model selection and parameter optimization.

Item 1(b), on the other hand, allows the system to work even on datasets too large to store and/or process on a single selection and optimization servers 102. The data may in fact reside in the data store 112, and simply be accessed by different selection and optimization servers 102, or chunks of the data may be stored directly on the different selection and optimization servers 102. In either arrangement, the selection and optimization servers 102 may load appropriate portions of their assigned data into memory and begin to form partial machine learning models independently of one another. The selection and optimization servers 102 may periodically communicate with each other, either synchronously or asynchronously, sending relevant statistics or model components to one another in order to allow the overall system to construct a global model pertaining to the entire dataset. The global model may be either replicated over all selection and optimization servers 102, stored in chunks (similar to the data) distributed over the different selection and optimization servers 102, or stored in the data store 112. In any case, the selection and optimization servers 102 may then use the global model to make predictions for test data (itself possibly distributed over the selection and optimization servers 102), which the system 100 as a whole uses to assess the chosen parameter configuration's fitness score.

Concerning Item 2 above, many of the same advanced algorithms mentioned above can train and evaluate machine learning models for a set of related parameter configurations simultaneously with no significant additional time cost. While not necessarily every parameter can engage in the simultaneous evaluation of different parameters settings, and not necessarily every machine learning method can simultaneously evaluate different settings for the same parameters, even one or a few parameters having multiple settings evaluated simultaneously can significantly speed up the machine learning method selection and parameter optimization process. The process 300 illustrated in FIG. 3 may be modified as follows:

(a) Rather than sampling individual parameter configurations, the method samples sets of parameter configurations that can be evaluated simultaneously. For example, it may select a set of parameter configurations that are all the same except for a regularization parameter.
(b) It then efficiently trains and assesses a corresponding set of machine learning models based on the set of parameter configurations.
(c) Finally, it incorporates all of the observed results into the learned distributions of parameters.

In processes (a) and (c) above, the method employs statistical techniques so as not to unfairly bias sampled parameter configurations towards or away from configurations that support more or fewer simultaneous evaluations, e.g. different machine learning methods with differing abilities to simultaneously train and assess multiple parameter settings, thereby ensuring similarly high-quality results as non-simultaneous evaluation.

Concerning Item 3 above, it is important to keep in mind that the space of possible parameter configurations is truly huge, and that, while the system and method described in the disclosure is able to efficiently navigate that space, more advanced users can save even more time by constraining the range of considered parameter configurations to avoid configurations that are already known to be inferior. Alternately, it may be the case that not every method that can solve a given problem is appropriate for an advanced user's specific need. For instance, a user may specifically need to generate an easily interpretable machine learning model, such as the decision tree, in order to gain insight about the data. In that case, it is appropriate to constrain the set of machine learning models that the method selection method and system can consider. The system chooses an optimal machine learning method and parameter configuration from within this set without further input from the user.

Accordingly, while the method and system remain completely parameter-free for novice users (i.e. the only required input is the data), experienced users can control the tuning process in several aspects, which include but are not limited to the following:

Users can specify the tuning range for some parameters, which could be the lower and/or upper bound of the parameter value as well as the quantization or step size;

Users can adjust the distribution types and/or prior distributions for some parameters;

Users can disable unwanted machine learning models and/or parameters and let the tuning process focus on the rest;

Users can fix the values for certain parameters and restrict all the generated parameter settings to contain these parameters with the given values;

Users can choose between different measures of fitness as well as how the potential gain is calculated;

Users can tune the stopping criteria; and

Instead of going through the regular tuning process described above, users can specify a file with a stored sequence of previously evaluated parameter configurations and associated scores as part of the input, which the parameter optimization unit 204 can use to prime its learned distributions and thereby reuse previous work to accelerate the tuning process. This form of use also makes the system 100 robust to interruptions because the tuning process can continue from a recently saved set of tested parameter configurations and associated scores (e.g. a break point) instead of having to start over.

It should be recognized that the preceding hierarchical structures 700a and 700b are merely illustrative and the components of a hierarchical structure (e.g. a root parameter, categorical parameter choices resulting in different subsequent parameters selections, a choice that results in more than one parameter being sampled, categorical parameters that don't sample additional parameters for all of their options, parameters that do not need to sample any follow up parameters, and the same parameter serving as a follow-up to more than one other parameter) may appear in various orders and combinations depending on the implementation. It should also be recognized that categorical parameters do not necessarily have follow up parameters. Also, while some implementations may directly support follow-up parameters for various conditions on the generated value of numerical parameters, it is possible to achieve the same effect even in implementations that only support follow-up parameters for categorical parameters. For example, if a user wants to sample Parameter B whenever Parameter A is less than 50, the system 100 may first define a categorical Parameter “A<50” to decided whether Parameter A should be sampled above or below 50 and then conditionally sample Parameter A in the appropriate range along with Parameter B under the appropriate condition. In this case, it should be understood that Parameter “A<50” may or may not be a true parameter of the candidate machine learning method, but instead merely a structural parameter meant to guide the distributions and sampling of other parameters that themselves may or may not be true parameters of the candidate machine learning method.

The foregoing description of the implementations of the present invention has been presented for the purposes of illustration and description. It is not intended to be exhaustive or to limit the present invention to the precise form disclosed. Many modifications and variations are possible in light of the above disclosure. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies, and other aspects are not mandatory or significant, and the mechanisms that implement the present invention or its features may have different names, divisions, and/or formats.

Furthermore, it should be understood that, the modules, units, routines, features, attributes, methodologies, and other aspects of the present invention can be implemented as software, hardware, firmware, or any combination of the three. Also, wherever a component, an example of which is a unit, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A method comprising:
receiving data;
determining, using one or more processors, a first candidate machine learning method;
tuning, using one or more processors, one or more parameters of the first candidate machine learning method;
determining, using one or more processors, that the first candidate machine learning method and a first parameter configuration for the first candidate machine learning method are the best based on a measure of fitness subsequent to satisfaction of a stop condition; and
outputting, using one or more processors, the first candidate machine learning method and the first parameter configuration for the first candidate machine learning method.

2. The method of claim 1 further comprising:
determining a second machine learning method;
tuning, using one or more processors, one or more parameters of the second candidate machine learning method, the second candidate machine learning method differing from the first candidate machine learning method; and
wherein the determination that the first candidate machine learning method and the first parameter configuration for the first candidate machine learning method are the best based on the measure of fitness includes determining that the first candidate machine learning method and the first parameter configuration for the first candidate machine learning method provide superior performance with regard to the measure of fitness when compared to the second candidate machine learning method with the second parameter configuration.

3. The method of claim 2, wherein the tuning of the one or more parameters of the first candidate machine learning method is performed using a first processor of the one or more processors and the tuning of the one or more parameters of the second candidate machine learning method is performed using a second processor of the one or more processors in parallel with the tuning of the first candidate machine learning method.

4. The method of claim 2, wherein a first processor of the one or more processors communicates with a second processor of the one or more processors in order to update the second processor's previously learned parameter distribution with a result of the first processor's tuning, wherein the result of the first processor's tuning is one of an intermediate and a complete tuning result.

5. The method of claim 2, wherein a greater portion of the resources of the one or more processors is dedicated to tuning the one or more parameters of the first candidate machine learning method than to tuning the one or more parameters of the second candidate machine learning method based on tuning already performed on the first candidate machine learning method and the second candidate machine learning method, the tuning already performed indicating that the first candidate machine learning method is performing better than the second machine learning method based on the measure of fitness.

6. The method of claim 2, wherein the user specifies the data, and wherein the first candidate machine learning method and the second machine learning method are determined and the tunings and determination that the first candidate machine learning method and a first parameter configuration for the first candidate machine learning method are the best based on a measure of fitness are performed automatically without user-provided information or with user-provided information.

7. The method of claim 1, wherein tuning the one or more parameters of the first candidate machine learning method further comprises:
setting a prior parameter distribution;
generating a set of sample parameters for the one or more parameters of the first candidate machine learning method based on the prior parameter distribution;
forming a new parameter distribution based on the prior parameter distribution and the previously generated set of sample parameters for each of the one or more parameters of the first candidate;
generating a new set of sample parameters for the one or more parameters of the first candidate machine learning method.

8. The method of claim 7, the method further comprising:
determining the stop condition is not met;
setting the new parameter distribution as a previously learned parameter distribution and setting the new set of sample parameters as the previously generated set of sample parameters; and
repeatedly forming a new parameter distribution based on the previously learned parameter distribution and the previously generated sample parameters for each of the one or more parameters of the first candidate machine learning candidate, generating a new set of sample parameters for the one or more parameters of the first candidate machine learning method, setting the new parameter distribution as the previously learned parameter distribution and setting the new set of sample parameters as the previously generated set of sample parameters before the stop condition is met.

9. The method of claim 7, wherein one or more of the determination of the first candidate machine learning method and the tuning of the one or more parameters of the first candidate machine learning method are based on a previously learned parameter distribution.

10. The method of claim 1, wherein the received data includes at least a portion of a Big Data data set and wherein the tuning of the one or more parameters of the first candidate machine learning method is based on the Big Data data set.

11. A system comprising:
one or more processors; and
a memory storing instructions that, when executed by the one or more processors, cause the system to:
receive data;
determine a first candidate machine learning method;
tune one or more parameters of the first candidate machine learning method;
determine that the first candidate machine learning method and a first parameter configuration for the first candidate machine learning method are the best based on a measure of fitness subsequent to satisfaction of a stop condition; and
output the first candidate machine learning method and the first parameter configuration for the first candidate machine learning method.

12. The system of claim 11, the memory storing instructions that, when executed by the one or more processors, cause the system to:
determine a second machine learning method;
tune one or more parameters of the second candidate machine learning method, the second candidate machine learning method differing from the first candidate machine learning method; and
wherein the determination that the first candidate machine learning method and the first parameter configuration for the first candidate machine learning method are the best based on the measure of fitness includes determining that the first candidate machine learning method and the first parameter configuration for the first candidate machine learning method provide superior performance with regard to the measure of fitness when compared to the second candidate machine learning method with the second parameter configuration.

13. The system of claim 12, wherein the tuning of the one or more parameters of the first candidate machine learning method is performed using a first processor of the one or more processors and the tuning of the one or more parameters of the second candidate machine learning method is performed using a second processor of the one or more processors in parallel with the tuning of the first candidate machine learning method.

14. The system of claim 12, wherein a first processor of the one or more processors alternates between the tuning the one or more parameters of the first candidate machine learning method and the tuning of the one or more parameters of the second candidate machine learning method.

15. The system of claim 12, wherein a greater portion of the resources of the one or more processors is dedicated to tuning the one or more parameters of the first candidate machine learning method than to tuning the one or more parameters of the second candidate machine learning method based on tuning already performed on the first candidate machine learning method and the second candidate machine learning method, the tuning already performed indicating that the first candidate machine learning method is performing better than the second machine learning method based on the measure of fitness.

16. The system of claim 12, wherein the user specifies the data, and wherein the first candidate machine learning method and the second machine learning method are selected and the tunings and determination are performed automatically without user-provided information or with user-provided information.

17. The system of claim 11, wherein tuning the one or more parameters of the first candidate machine learning method further comprises:
setting a prior parameter distribution;
generating a set of sample parameters for the one or more parameters of the first candidate machine learning method based on the prior parameter distribution;
forming a new parameter distribution based on the prior parameter distribution and the previously generated set of sample parameters for each of the one or more parameters of the first candidate;
generating a new set of sample parameters for the one or more parameters of the first candidate machine learning method.

18. The system of claim 17, the memory storing instructions that, when executed by the one or more processors, cause the system to:
determine the stop condition is not met;
set the new parameter distribution as a previously learned parameter distribution and setting the new set of sample parameters as the previously generated set of sample parameters; and
repeatedly form a new parameter distribution based on the previously learned parameter distribution and the previously generated sample parameters for each of the one or more parameters of the first candidate machine learning candidate, generate a new set of sample parameters for the one or more parameters of the first candidate machine learning method, set the new parameter distribution as the previously learned parameter distribution and set the new set of sample parameters as the previously generated set of sample parameters before the stop condition is met.

19. The system of claim 17, wherein one or more of the determination of the first candidate tuning method and the tuning of the one or more parameters of the first candidate machine learning method are based on a previously learned parameter distribution.

20. The system of claim 11, wherein the received data includes at least a portion of a Big Data data set and wherein the tuning of the one or more parameters of the first candidate machine learning method is based on the Big Data data set.
